(19) United States
(12) Patent Application Publication
(10) Pub. No.: US 2008/0149282 A1
(43) Pub. Date: Jun. 26, 2008

(54) Window screen frame member

(76) Inventor: Gerard Therrien, St-Apollinaire (CA)

Correspondence Address: Eric Fincham, 316 Knowlton Road, Lac Brome, QC, J0E 1V0, omitted

(21) Appl. No.: 11/999,681

(22) Filed: Dec. 5, 2007

(30) Foreign Application Priority Data
Dec. 22, 2006 (CA) 2,571,985

(51) Int. Cl. E06B 9/24

(52) U.S. Cl. 160/371

(57) ABSTRACT

A screen framing member which comprises a body portion, a generally U-shaped portion designed to receive a retaining spline, and a gripping portion extending inwardly, the gripping portion being formed on its side opposite the U-shaped portion and extending substantially the entire length of the screen framing member.

### FIELD OF THE INVENTION

The present invention relates to screens and more particularly, relates to screens used in a building structure.

### BACKGROUND OF THE INVENTION

In modern day windows, a screen is usually provided as part of the original window. The screen member must be lightweight and easily removable such that access may be had to the glass portion of the window. Traditionally, the screen member is formed by frame members along the top, bottom and sides, the frame members being joined together at the corners by suitable means. The joining of the corners may conveniently be accomplished by means of a screen corner member.

The screen is frequently held in place by means of metallic springs which sit in channels formed in the window. The springs, on one side of the screen, push the screen into an opposite channel. Alternately, a pin-like element may be provided in the sides of the screen frame, the pins being movable to sit within a recess or aperture formed in the window.

On conventional screens, there also exists the problem of inserting and removing the screens from the window frame. To date, many screens simply rely on the user being able to exert enough pressure on the sides to move the same such that the screen may be grasped. It also has been known to provide tab like members on the side to facilitate the installation and removal of the screens. However, aesthetically speaking, the use of tab members is not desirable. Furthermore, the tab members are frequently flimsy enough that they break off from the screen.

Manufacturers of windows generally fabricate the windows using proprietary designs. Accordingly, there is little in the way of standards which exist. As a result, independent suppliers of screens have to design and manufacture a number of different styles of screens and frames.

### SUMMARY OF THE INVENTION

It is an object of the present invention to provide a novel screen frame which is aesthetic and includes built-in handles for removing the screen from the window.

As used herein, the term “window screen” includes those screen members which may be utilized for other purposes such as in doors or the like.

According to the present invention, there is provided a screen framing member having an inwardly facing side and an outwardly facing side comprising a body portion, a generally U-shaped portion designed to receive a retaining spline on the outwardly facing side, and a gripping portion, the gripping portion being formed on the inwardly facing side, the gripping portion extending substantially the entire length of the screen framing member.

According to a further aspect of the present invention, there is provided, a window screen comprising a rectangular frame, the rectangular frame having a top frame member, a bottom frame member, and first and second side frame members, the rectangular frame having an inwardly facing side and an outwardly facing side, each of the frame members having a generally U-shaped portion designed to receive a retaining spline, the U-shaped portion being located on the outwardly facing side of the frame members, a screen extending between the frame members, and the side frame members each having a gripping portion on the inwardly facing side of the frame, the gripping portion extending substantially the entire length of the side frame members.

The screen frame of the present invention preferably utilizes a screen corner such as shown in co-pending Canadian Application S. N. 2,573,823 filed Jan. 12, 2007. However, it will be understood that other screen corners may be utilized if so desired.

As used herein, the terms inward and outward are merely for purposes of convenience. The inwardly facing side of the screen would be that which faces the interior of the room while the outwardly facing side is that which would face the window and the exterior of the room.

The screen framing member is preferably formed as an integral member—i.e. it is formed as a single piece. Conveniently, the member comprises sheet metallic material suitably formed. A preferred material is aluminum. Naturally, the member could also be molded from a suitable plastic material.

As is known in the art, the screen framing member will include a generally U-shaped recess which is adapted to receive an edge of the screening with a spline holding the screen in place. The spline itself may be formed of a rubberized type of material or alternatively, as is also known in the art, of a metallic material such as aluminum.

The body portion of the screen framing member is, at either end thereof, designed to received a protruding element of a corner member such as shown in the aforementioned co-pending application.

The gripping portion is formed proximate one side of the body member and extends outwardly therefrom. The gripping portion will generally be located on an inwardly facing portion of the screen framing member with the U-shaped recess being on the other side thereof. Naturally, many different configurations can be used for the gripping portion; a preferred arrangement is one wherein there is a relatively straight section extending outwardly from the body portion and with a further inwardly extending angled portion. This permits the fingers of the installer to easily grip the screen.

For aesthetic purposes, there may be provided a flange portion which extends from on one side of each of the body portions towards each other.

### BRIEF DESCRIPTION OF THE DRAWINGS

Having thus generally described the invention, reference will be made to the accompanying drawings illustrating an embodiment thereof, in which:

FIG. 1 is a perspective view of a window screen utilizing the frame members of the present invention;

FIG. 2 is a perspective view of a frame member according to the present invention;

FIG. 3 is a side sectional view of a non crimped side frame member;

FIG. 4 is a view similar to FIG. 3 showing the crimped frame member; and

FIG. 5 is an exploded view illustrating the side frame member with a corner for attaching two frame members together.

### DETAILED DESCRIPTION OF THE INVENTION

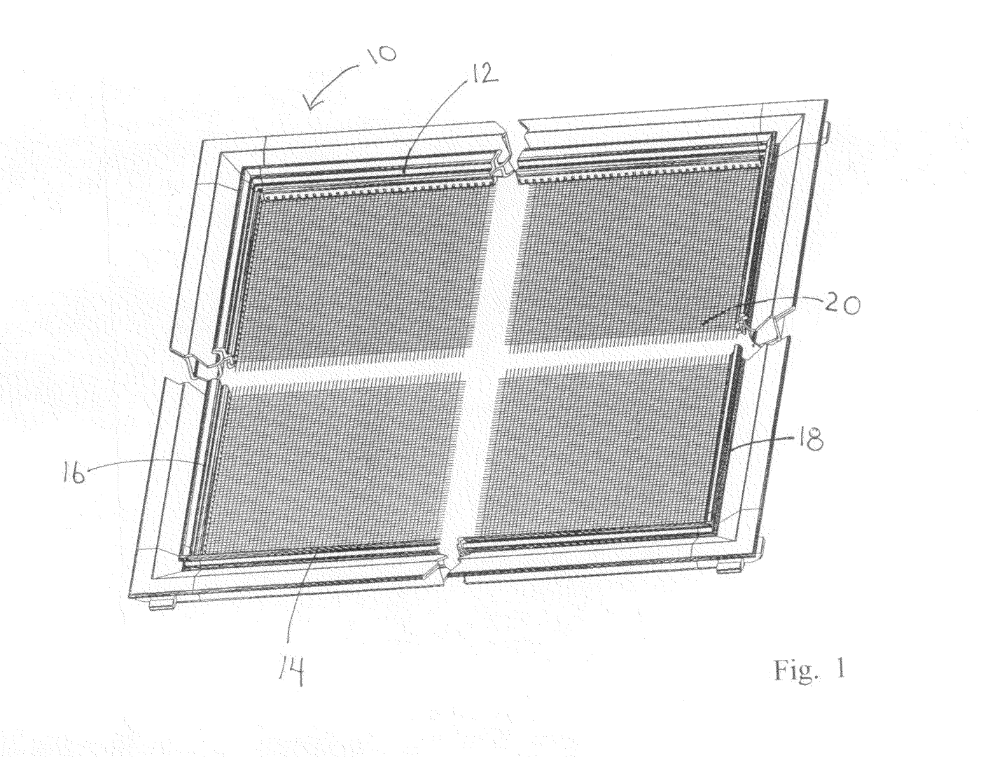

Referring to the drawings in greater detail, and by reference characters thereto, there is illustrated in FIG. 1 a typical window screen which is generally designated by reference numeral 10. Window screen 10 will include a top frame member 12, a bottom frame member 14, a side frame member 16 and a second side frame member 18. Extending between the frame members is screening 20.

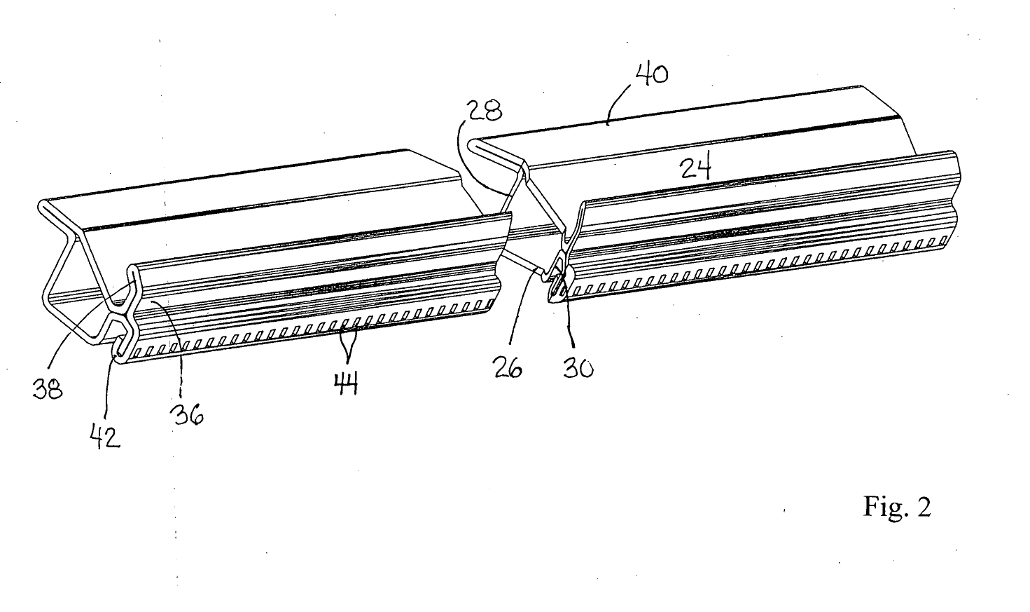

Side frame member 16 is illustrated in greater detail in FIGS. 2, 3 and 4 and reference will now be had thereto.

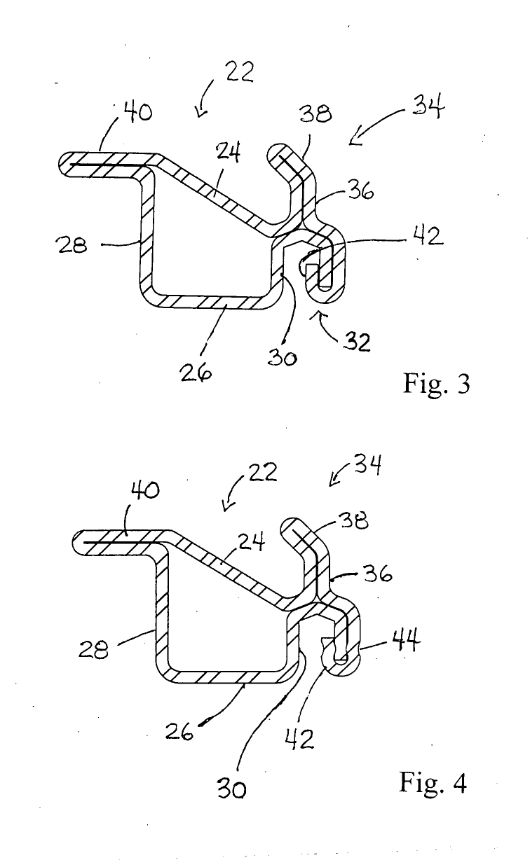

Frame member 16 is substantially identical to the other frame members and includes a central body portion generally designated by reference numeral 22. Central body portion 22 is defined by an upper wall 24, a bottom wall 26, and side walls 28, 30. As will be best seen in FIGS. 3 and 4, side wall 30 has a lesser depth than side wall 28 and accordingly, top wall 24 is angled or sloping.

On one side of side frame member 16, there is provided a U-shaped channel generally designated by reference numeral 32 and which channel 32 is designed to receive a spline as is known in the art. In the illustrated embodiment, there is a leg portion 42 and which is subject to crimps 44. It will be noted that leg portion 32 can help retain a spline within U-shaped channel 32.

On the inwardly facing side of side frame member 16, there is provided a gripping section generally designated by reference numeral 34. Gripping section 34 includes a straight section 36 and an angled section 38. As may be seen from these figures, there is also provided a flange portion 40 which extends towards the screen 20.

As may be seen, side frame member 16 is formed of a single piece of material, preferably metallic, and is formed by conventional bending machines.

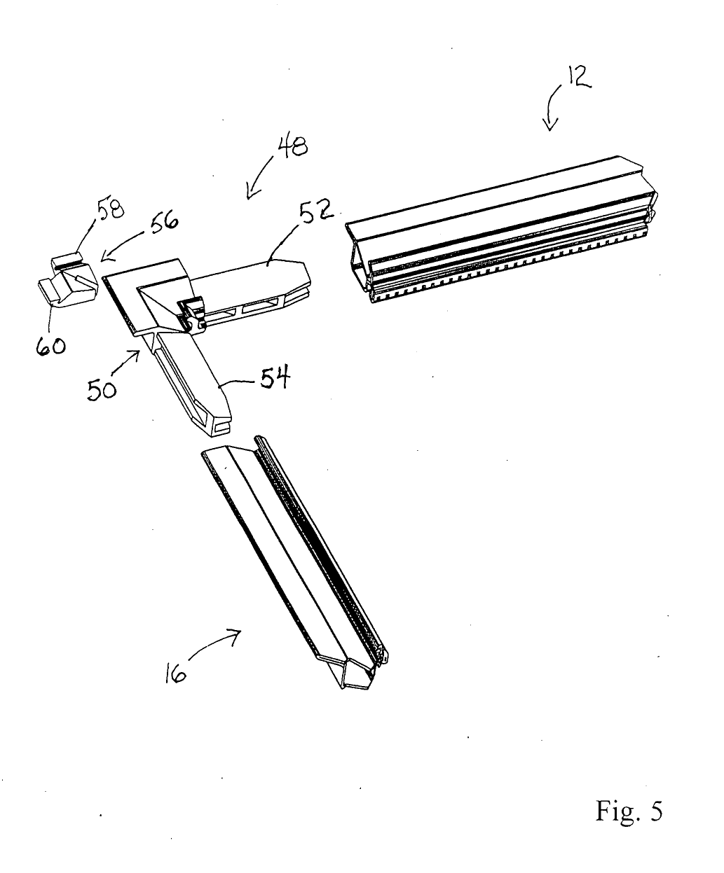

As may be seen from FIG. 5, a typical screen may have the frame members connected together by means of a screen corner generally designated by reference numeral 48. Screen corner 48 includes a central body portion 50 and mutually perpendicularly extending legs 52 and 54. Legs 52 and 54 are shaped to fit within the recess defined by top wall 24, bottom wall 26, and side walls 28, 30.

In the illustrated embodiment, a resilient member 58 is inserted within body portion 50 of screen corner 48. Resilient member 56 includes a pair of retaining tabs 58 and 60 which extend outwardly and which are utilized to retain the screen in position.

It will be understood that the above described embodiment is for purposes of illustration only and that changes and modifications may be made thereto without departing from the spirit and scope of the invention.

I claim:

1. A screen framing member having an inwardly facing side and an outwardly facing side comprising:
a body portion;
a generally U-shaped portion designed to receive a retaining spline on said outwardly facing side; and
a gripping portion, said gripping portion being formed on said inwardly facing side, said gripping portion extending substantially the entire length of the screen framing member.

2. The screen framing member of claim 1 wherein said gripping portion has a first straight section extending outwardly, said first straight section terminating in an angled section to facilitate grasping thereof.

3. The screen framing member of claim 2 wherein said screen framing member is formed as a single piece.

4. The screen framing member of claim 2 wherein said screen framing member is formed of a metallic material.

5. The screen framing member of claim 4 wherein said body portion has a substantially quadralateral configuration.

6. The screen framing member of claim 5 wherein said body portion is defined by an inwardly facing wall, an outwardly facing wall, and a pair of side walls extending between said inwardly facing wall and said outwardly facing wall one of said side-walls having a depth less than the other of said side walls.

7. The screen framing member of claim 6 further including a flange extending outwardly from said body portion, said flange being substantially parallel to said inwardly facing wall.

8. A window screen comprising:
a rectangular frame, said rectangular frame having a top frame member, a bottom frame member, and first and second side frame members, said rectangular frame having an inwardly facing side and an outwardly facing side;
each of said frame members having a generally U-shaped portion designed to receive a retaining spline, said U-shaped portion being located on said outwardly facing side of said frame members;
a screen extending between said frame members; and
said side frame members each having a gripping portion on said inwardly facing side of said frame, said gripping portion extending substantially the entire length of said side frame members.

9. The window screen of claim 8 wherein said gripping portions each have a first straight section extending outwardly, said first straight sections terminating in angled sections to facilitate grasping thereof.

10. The screen of claim 9 wherein said screen framing members are formed as a single piece of a metallic material.
